(19) United States
(12) Patent Application Publication
(10) Pub. No.: US 2007/0183385 A1
(43) Pub. Date: Aug. 9, 2007

(54) Apparatus and method for distinguishing a frame on channel shared by multiple users

(76) Inventors: Hao Bi, Wheeling, IL (US); Sean M. McBeath, Keller, TX (US); John D. Reed, Arlington, TX (US)

Correspondence Address: MOTOROLA INC, 600 NORTH US HIGHWAY 45, ROOM AS437, LIBERTYVILLE, IL, 60048-5343, US

(21) Appl. No.: 10/683,761

(22) Filed: Oct. 10, 2003

(51) Int. Cl. H04B 7/216

(52) U.S. Cl. 370/342

(57) ABSTRACT

An apparatus and method of distinguishing a frame on a channel shared by a plurality of users. A unique identifier can be obtained for each of a set of mobile communication devices. A message intended for one of the mobile communication devices can be obtained. The message can be scrambled using a long code generated using a mobile communication device specific long code mask to obtain a scrambled message. The unique identifier can be incorporated into the scrambled message for a frame intended for a selected mobile communication device. The frame can then be transmitted. A radio frequency signal can be received for the frame. Demodulation can be performed on the signal to obtain a scrambled signal. A unique identifier can be extracted from the scrambled signal. The unique identifier extracted from the scrambled signal can be examined to determine if the signal is intended for a mobile communication device.

### BACKGROUND

1. Field

The present disclosure is directed to a method and apparatus for distinguishing a frame on a channel shared by multiple users. More particularly, the present disclosure is directed to a method and apparatus for using a unique identifier on a scrambled signal to determine whether a frame is intended for a specific user.

2. Description of Related Art

Presently, during a broadcast multicast services session, a forward dedicated control channel can be used for signaling addressed to an individual mobile station. The single forward dedicated control channel can be shared by multiple mobile stations by using time division multiplexing and using a long code mask to scramble the signaling so only a specific mobile station can read the signaling. The mobile station can then use its own long code mask to descramble the received symbols and then do decoding and cyclic redundancy code checking. The mobile station can determine it received the frame correctly if it passes cyclic redundancy code checking.

Unfortunately, since both using the wrong long code mask and decoding errors can lead to cyclic redundancy code checking failures, the mobile station cannot distinguish between an erasure or improperly received signal due to decoding error and a frame intended for another mobile station that uses the same forward dedicated control channel. Also, a mobile station cannot utilize cyclic redundancy code checking to determine a discontinuous transmission when the forward dedicated control channel is turned off. Furthermore, because the mobile station cannot distinguish between sources of cyclic redundancy coding check failures, the mobile station cannot adequately determine when to increase or decrease an outer loop power setpoint to account for erasures.

### BRIEF DESCRIPTION OF THE DRAWINGS

The embodiments of the present invention will be described with reference to the following figures, wherein like numerals designate like elements, and wherein:

FIG. 1 is an exemplary block diagram of a system according to one embodiment;

FIG. 2 is an exemplary block diagram of a communication device according to one embodiment;

FIG. 3 is an exemplary flowchart illustrating the operation of a controller according to one embodiment;

FIG. 4 is an exemplary flowchart illustrating the operation of a communication device according to another embodiment;

FIG. 5 is an exemplary block diagram of a frame determination module according to one embodiment; and

FIG. 6 is an exemplary block diagram of a network controller according to one embodiment.

### DETAILED DESCRIPTION

The disclosure provides an apparatus and method of distinguishing a frame on a channel shared by a plurality of users. According to one embodiment, a unique identifier can be obtained for each of a set of communication devices. A message intended for one of the communication devices can be obtained. The message can be scrambled using a long code generated using a communication device specific long code mask to obtain a scrambled message. The unique identifier can be incorporated into the scrambled message for a frame intended for a selected communication device. The frame can then be transmitted. According to a related embodiment, a radio frequency signal can be received at a communication device for the frame. Demodulation can be performed on the signal to obtain a scrambled signal. A unique identifier can be extracted from the scrambled signal. The unique identifier extracted from the scrambled signal can be examined to determine if the signal is intended for the communication device.

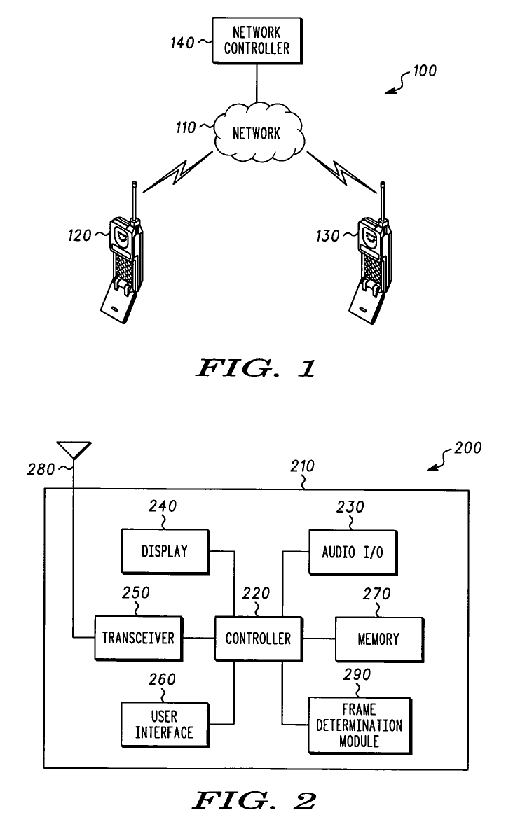

FIG. 1 is an exemplary block diagram of a system 100 according to a related embodiment. The system 100 includes a network controller 140, a network 110, and one or more terminals 120 and 130. Terminals 120 and 130 may include telephones, wireless telephones, cellular telephones, PDAs, pagers, personal computers, mobile communication devices, or any other device that is capable of sending and receiving communication signals on a network that may include a wireless network. A mobile communication device can be any device capable of sending and receiving wireless communication signals.

In an exemplary embodiment, the network controller 140 is connected to the network 110. The network controller 140 may be located at a base station, at a radio network controller, or anywhere else on the network 110. The network 110 may include any type of network that is capable of sending and receiving signals, such as wireless signals. For example, the network 110 may include a wireless telecommunications network, a cellular telephone network, a cdma2000 network, W-CDMA network, a satellite communications network, and other like communications systems capable of sending and receiving communication signals. Furthermore, the network 110 may include more than one network and may include a plurality of different types of networks. Thus, the network 110 may include a plurality of data networks, a plurality of telecommunications networks, a combination of data and telecommunications networks and other like communication systems capable of sending and receiving wireless messaging service messages.

In operation, according to one embodiment, the network controller 140 can obtain a unique identifier for each of the terminals 120 and 130. This unique identifier may be obtained from the terminals, from a local database, by assigning them, or from any other resource. The unique identifier can be a mobile communication device or mobile station identification number, a subscriber identity, or any other identifier that can be used to uniquely identify a terminal on a shared channel. The unique identifier can also be a mobile communication device identity code generated by performing length 16 Walsh block coding on the mobile communication device identification number.

The network controller 140 can obtain a message intended for one of the terminals 120. This message may be a message to be sent on a forward dedicated control channel during a broadcast multicast session. The network controller 140 can scramble the message. For example, the network controller 140 can scramble the message using a long code generated using a mobile communication device-specific long code mask to obtain a scrambled message. The network controller 140 can then incorporate the unique identifier into the scrambled message for a frame intended for the selected mobile communication device 120. For example, the network controller 140 can append the unique identifier to the scrambled message, puncture the unique identifier into a power control section or any portion of the scrambled message, or otherwise incorporate the unique identifier into the scrambled message. The network controller 140 can then transmit the frame. For example, the network controller 140 can transmit the frame on a forward dedicated control channel.

According to another related embodiment, the network controller 140 can identify a set of mobile communication devices 120 and 130. For example, these mobile communication devices may be devices that are receiving broadcast multicast services. The controller can then obtain a unique identifier for at least one of the mobile communication devices 120. The network controller 140 can obtain information bits, such as a message, intended for the mobile communication device 120. This message may be a message to be sent on a forward dedicated control channel during a broadcast multicast session. The network controller 140 can then append cyclic redundancy code bits to the information bits to obtain a cyclic redundancy coded message. The network controller 140 can perform channel coding on the cyclic redundancy coded message to obtain a channel coded message. The network controller 140 can then scramble the message using a long code generated using a mobile communication device-specific long code mask to obtain a scrambled message. The network controller 140 can incorporate the unique identifier into the scrambled message for a frame intended for the selected mobile communication device 120. For example, the network controller 140 can append the unique identifier to the scrambled message, puncture the unique identifier into a power control section or any portion of the scrambled message, or otherwise incorporate the unique identifier into the scrambled message. As another example, the network controller 140 can puncture the unique identifier by inserting the unique identifier into a power control subchannel section of the scrambled message. The network controller 140 can then transmit the frame. For example, the network controller 140 can transmit the frame on a forward dedicated control channel intended for the selected mobile communication device 120.

According to another related embodiment, when the network controller 140 uses a forward dedicated control channel or forward fundamental channel in a broadcast multicast service to carry signaling to different terminals 120 and 130, the network controller 140 can puncture a unique identifier corresponding to a desired terminal 120 into the forward channel where power control bits are typically punctured. If cyclic redundant code checking fails at the terminal 120 after receiving a frame, the terminal 120 can look at the unique identifier to see if the frame is targeted to the terminal 120. Thus, the terminal 120 can distinguish between erasures and frames targeted to other terminals. The terminal 120 can also thus distinguish between erasures and discontinuous transmissions. Accordingly, the outer loop residing on a terminal 120 can be driven only by the frames targeted to the terminal 120 and a power setpoint can be increased based on erasures of frames due to decoding error of the frames targeted for the terminal 120.

To generate good reception of the unique identifier, at the network controller 140, a reliable error correction coding can be used for the unique identifier. For example, block coding can be used to map a 4-bit unique identifier into a length-16 Walsh code. To do this, the decimal representation of the 4-bit number can be used to index a row in a 16×16 Hadamard matrix. The resulting Walsh code can then be punctured onto a forward dedicated control channel or a forward fundamental channel. Then, at the terminal 120, a block decoder can be used to detect whether the unique identifier is present or not on the forward dedicated control channel or the forward fundamental channel.

Inner loop power control can be carried out quickly, for example, at say 800 Hz. To do this, a terminal 120, such as a communication device, can measure a received signal strength and compare it against a threshold stored in the communication device. Where the received signal strength can be Eb/Nt where Eb is bit energy and Nt is noise spectrum density. If the received Eb/Nt is greater than the threshold, the communication device can instruct a base station or network controller 140 to power down, for example by 0.5 dB, so the communication device can instruct the base station or network controller 140 to lower its transmission power. If the received Eb/Nt is less than the threshold, the communication device can instruct the base station or network controller 140 to power up, for example by 0.5 dB, so the communication device can instruct the base station or network controller 140 to raise its transmission power. The setpoint can also be any derivative from Eb/Nt threshold. Outer loop power can be slower, for example, 50 Hz. Here, when the mobile detects a frame error, it can increase the outer loop threshold, for example, by 0.5 dB. When the communication device detects a successful frame, it can decrease the outer loop threshold, for example, by 0.5 dB/99. This process of changing the received Eb/Nt threshold according to whether a frame is in error or not allows the mobile target an frame error rate, e.g., 1%.

FIG. 2 is an exemplary block diagram of a mobile communication device 200, such as the terminal 120 or the terminal 130, according to one embodiment. The mobile communication device 200 can include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, a memory 270 coupled to the housing 210, and an antenna 280 coupled to the housing 210 and the transceiver 250. The display 240 can be a liquid crystal display (LCD), a light emitting diode (LED) display, a plasma display, or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch pad, a joystick, an additional display, or any other device useful for providing an interface between a user and an electronic device. The memory 270 may include a random access memory, a read only memory, an optical memory, a subscriber identity module memory, or any other memory that can be coupled to a mobile communication device.

In operation, according to one embodiment, the mobile communication device 200 can receive a radio frequency signal for a frame. For example, the mobile communication device 200 can receive a frame on a forward dedicated control channel. The mobile communication device 200 can perform demodulation on the signal to obtain a scrambled signal. The mobile communication device 200 can then extract a unique identifier from the scrambled signal. The unique identifier can be extracted at any point during or after the process of receiving a signal, a frame, or the like. The unique identifier can be a group identifier that identifies at least one mobile communication device for which the signal is intended, a mobile station identity that identifies a specific mobile communication device for which the signal is intended, or any other unique identifier. Also, the unique identifier can be obtained from a power control section of the scrambled signal or from any other portion of the signal. The mobile communication device 200 can then examine the unique identifier extracted from the scrambled signal to determine if the signal is intended for the mobile communication device 100.

The mobile communication device 200 can also descramble the scrambled signal using a long code mask to obtain a channel encoded signal, channel decode the channel coded signal to obtain a cyclic redundancy coded signal, cyclic redundancy code check the cyclic redundancy coded signal, determine if the cyclic redundancy coded signal fails the cyclic redundancy code check, and increase a received Eb/Nt set point if in the examining step it is determined that the signal is intended for the mobile communication device but the cyclic redundancy coded signal fails the cyclic redundancy code check. Further, the mobile communication device can decrease a received Eb/Nt set point if in examining it is determined that the signal is intended for the mobile communications device but the cyclic redundancy coded signals pass the cyclic redundancy code check.

After extracting the unique identifier, the mobile communication device 200 can additionally descramble the scrambled signal to obtain a channel encoded signal and channel decode the channel encoded signal to obtain a cyclic redundancy coded signal.

According to another related embodiment, the mobile communication device 200 can receive a radio frequency signal for a frame, perform demodulation on the signal to obtain a scrambled signal, descramble the scrambled signal to obtain a channel encoded signal, channel decode the channel encoded signal to obtain a cyclic redundancy coded signal, cyclic redundancy code check the cyclic redundancy coded signal, and if the cyclic redundancy coded signal fails the cyclic redundancy code check, examine a unique identifier to determine if the signal is intended for the mobile communication device 200. The mobile communication device 200 can receive the radio frequency signal for a frame on a forward dedicated control channel. Also, the unique identifier can be a group identifier that identifies at least one mobile communication device for which the signal is intended or a mobile station identity that identifies a specific mobile communication device for which the signal is intended. The unique identifier can be obtained from a power control section or any portion of the scrambled signal. The mobile communication device 200 can further attempt to descramble the scrambled signal using a long code mask, determine the scrambled signal is unsuccessfully descrambled, and increase a received Eb/Nt set point if in the examining step it is determined that the signal is intended for the mobile communication device but the scrambled signal is unsuccessfully descrambled. Additionally, the radio frequency signal can be received on a forward dedicated control channel.

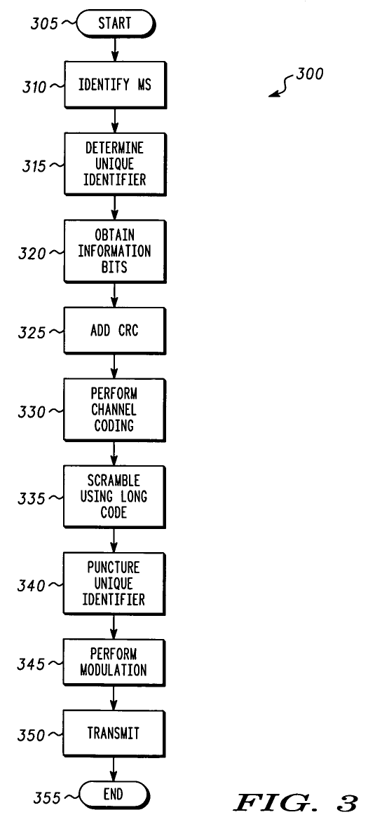

FIG. 3 is an exemplary flowchart 300 illustrating the operation of the network controller 140 according to one embodiment. In step 305, the flowchart begins. In step 310, the network controller 140 identifies at least one or a set of mobile communication devices. For example, the network controller 140 can identify a set of mobile communication devices as those intended to receive broadcast multicast service communications. In step 315, the network controller 140 can determine a unique identifier for at least one mobile communication device. In step 320, the network controller 140 can obtain information bits for communication to the mobile communication device. For example, these information bits may include information for a specific mobile communication device sent on a forward dedicated control channel. In step 325, the network controller 140 can add cyclic redundancy code bits to the information bits to obtain a cyclic redundancy coded message. In step 330, the network controller 140 can perform channel coding on the cyclic redundancy coded message to obtain a channel coded message. In step 335, the network controller 140 can scramble the channel coded message using a long code generated using a mobile communication device specific long code mask to obtain a scrambled message. This long code mask can be specific to a specific mobile communication device in that only the specific mobile communication device has the proper long code to descramble the message. In step 340, the network controller 140 incorporates, such as punctures, the unique identifier into the scrambled message for a frame intended for the specific mobile communication device. In 345, the network controller 140 modulates the scrambled message for transmission. In step 350, the network controller 140 transmits the message. In step 355, the flowchart ends. It is understood that it is not necessary to perform all the steps for proper operation of the flowchart 300.

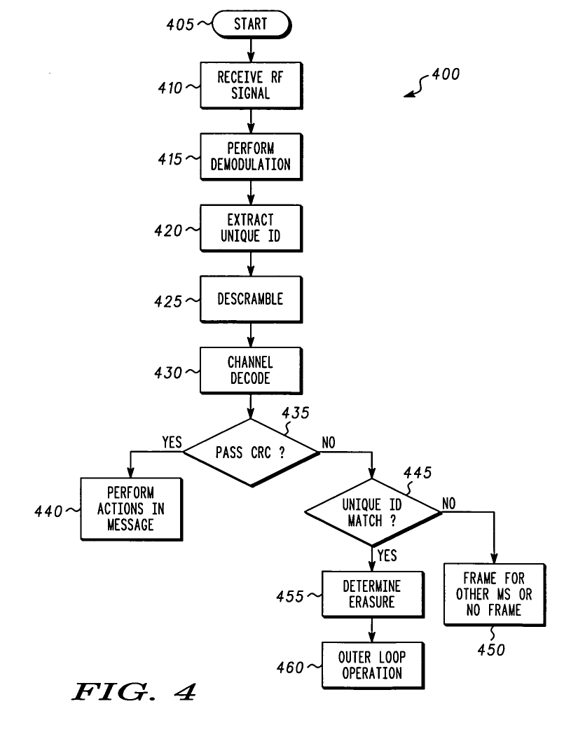

FIG. 4 is an exemplary flowchart 400 illustrating the operation of a device, such as a communication device, the mobile communication device 200, the terminal 120, or the like, according to one embodiment. In step 405, the flowchart begins. In step 410, the device can receive a radio frequency signal. For example, the device can receive a frame on a forward dedicated control channel. In step 415, the device can perform demodulation on the signal to obtain a scrambled signal. In step 420, the device can extract a unique identifier from the scrambled signal. The device may extract the unique identifier at any stage of the process described in the flowchart 400. In step 425, the device can descramble the scrambled signal to obtain a channel encoded signal. In step 430, the device channel can decode the channel encoded signal to obtain a cyclic redundancy coded signal. In step 435, the device can cyclic redundancy code check the cyclic redundancy coded signal. If the cyclic redundancy coded signal passes the cyclic redundancy code check in step 435, in step 440, the device can examine the information bits of the message and performs any actions required by the information bits and adjust the set point for outer loop power control. If the cyclic redundancy coded signal fails the cyclic redundancy code check in step 435, in step 445, the device can determine if the unique identifier extracted from the signal matches the unique identifier of the device. If the unique identifier extracted from the signal does not match the unique identifier of the device, in step 450 the device can decide either the frame was not intended for the device, or that there was no frame sent. If the unique identifier extracted from the signal matches the unique identifier of the device, in step 455, the device determines there was an erasure of the frame. For example, the device can determine that the frame was intended for the device, but that signal noise caused the frame to be improperly received. In step 460, the device can perform an outer loop operation of increasing a received Eb/Nt set point to improve a signal-to-noise ratio to properly receive the frame. The step of checking a unique identifier match can be performed at any point of the process illustrated in the flowchart 400. Also, it is not necessary to perform all the steps for proper operation. For example, the flowchart 400 can be useful without performing the outer loop operation of step 460.

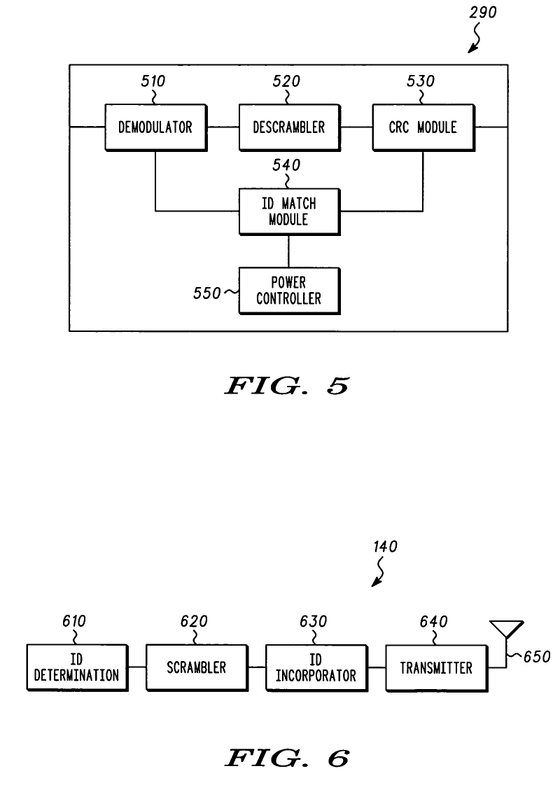

FIG. 5 is an exemplary block diagram of the frame determination module 290 according to one embodiment. Different features of the frame determination module 290 may exist on the frame determination module 290 or at different locations of the mobile communication device 200. The frame determination module 290 can include a demodulator 510 coupled to the transceiver 250, a descrambler 520 coupled to the demodulator 510, and a unique identifier match module 540. The demodulator 510 can demodulate a received signal to obtain a scrambled signal. The descrambler 520 can descramble the scrambled signal to obtain a descrambled signal. The unique identifier match module 540 can extract a unique identifier from the received signal and examine the unique identifier extracted from the received signal to determine if the signal is intended for the communication device 200. The frame determination module 290 can also include a cyclic redundancy code check module 530 coupled to the descrambler 520. The cyclic redundancy code check module 530 can be configured to cyclic redundancy code check the descrambled signal.

The frame determination module 290 can additionally include a power controller 550. Thus, the descrambler 520 can attempt to descramble the scrambled signal using a long code mask and determine the scrambled signal is unsuccessfully descrambled. The power controller 550 can then increase a transmission, reception, or transceiver power set point if it is determined that the signal is intended for the mobile communication device 200 but the scrambled signal is unsuccessfully descrambled. The power controller can also decrease the Eb/Nt set point if it is determined that the signal is intended for the mobile communications device and the scrambled signal is successfully descrambled.

FIG. 6 is an exemplary block diagram of the network controller 140 according to one embodiment. Each element can exist as hardware or software on the network controller 140 or elsewhere on the network 110. The network controller 140 can include a unique identifier determination module 610, a scrambler 620, a unique identifier incorporator 630, a transmitter 640, and an antenna 650. The unique identifier determination module 610 can determine a unique identifier for a communication device recipient of a signal. The scrambler 620 can scramble the signal using a long code generated using a communication device specific long code mask to obtain a scrambled signal. The unique identifier incorporator 630 can incorporate the unique identifier into the scrambled signal for a frame intended for the communication device. The transmitter 640 can transmit the frame using the antenna 650. For example, the transmitter 640 can transmit the frame on a forward dedicated control channel during a broadcast multicast service session. The unique identifier incorporator 630 can incorporate the unique identifier into the scrambled signal by puncturing the unique identifier into a power control section or any portion of the scrambled signal. The unique identifier can be a mobile station identity code derived from a mobile station identity number of the communication device.

The method of this invention is preferably implemented on a programmed processor. However, the network controller 140, the controller 220, and/or the frame determination module 290 may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures may be used to implement the processor functions of this invention.

While this invention has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the invention by simply employing the elements of the independent claims. Accordingly, the preferred embodiments of the invention as set forth herein are intended to be illustrative, not limiting. Various changes may be made without departing from the spirit and scope of the invention.

What is claimed is:

1. A method at a communication device of distinguishing a frame on a channel shared by a plurality of users, the method comprising:
receiving a radio frequency signal for a frame;
performing demodulation on the signal to obtain a scrambled signal;
extracting a unique identifier from the scrambled signal; and
examining the unique identifier extracted from the scrambled signal to determine if the signal is intended for the communication device.

2. The method according to claim 1, wherein receiving further comprises receiving a radio frequency signal for a frame on a forward dedicated control channel.

3. The method according to claim 1, wherein the unique identifier comprises a group identifier that identifies at least one communication device for which the signal is intended.

4. The method according to claim 1, wherein the unique identifier comprises a mobile station identity that identifies a specific communication device for which the signal is intended.

5. The method according to claim 1, wherein the unique identifier is obtained from a set of segments of the scrambled signal.

6. The method according to claim 1, further comprising:
descrambling the scrambled signal using a long code mask to obtain a channel encoded signal;
channel decoding the channel encoded signal to obtain a cyclic redundancy coded signal;
cyclic redundancy code checking the cyclic redundancy coded signal;
determining the cyclic redundancy coded signal fails the cyclic redundancy code check;
increasing a received signal quality set point if in the examining step it is determined that the signal is intended for the communication device but the cyclic redundancy coded signal fails the cyclic redundancy code check; and
decreasing the received signal quality set point if in the examining step it is determined that the signal is intended for the communication device but the cyclic redundancy coded signal passes the cyclic redundancy code check.

7. The method according to claim 1, further comprising, after extracting the unique identifier,
descrambling the scrambled signal to obtain a channel encoded signal: and
channel decoding the channel encoded signal to obtain a cyclic redundancy coded signal.

8. A method at a mobile communication device of distinguishing a frame on a channel shared by a plurality of users, the method comprising:
receiving a radio frequency signal for a frame;
performing demodulation on the signal to obtain a scrambled signal;
descrambling the scrambled signal to obtain a channel encoded signal;
channel decoding the channel encoded signal to obtain a cyclic redundancy coded signal;
cyclic redundancy code checking the cyclic redundancy coded signal; and
if the cyclic redundancy coded signal fails the cyclic redundancy code check, examining a unique identifier to determine if the signal is intended for the mobile communication device.

9. The method according to claim 8, wherein receiving further comprises receiving a radio frequency signal for a frame on a forward dedicated control channel.

10. The method according to claim 8, wherein the unique identifier comprises a group identifier that identifies at least one mobile communication device for which the signal is intended.

11. The method according to claim 8, wherein the unique identifier comprises a mobile station identity that identifies a specific mobile communication device for which the signal is intended.

12. The method according to claim 8, wherein the unique identifier is obtained from a set of segments of the scrambled signal.

13. The method according to claim 8, further comprising:
attempting to descramble the scrambled signal using a long code mask;
determining the scrambled signal is unsuccessfully descrambled; and
increasing a signal quality set point if in the examining step it is determined that the signal is intended for the mobile communication device but the scrambled signal is unsuccessfully descrambled.

14. The method according to claim 8, further comprising receiving a radio frequency signal for a frame on a forward dedicated control channel.

15. A method on a network of distinguishing a frame on a channel shared by a plurality of users, the method comprising:
determining a unique identifier for each of a set of mobile communication devices;
obtaining a message intended for one of the mobile communication devices;
scrambling the message using a long code generated using a mobile communication device specific long code mask to obtain a scrambled message;
incorporating the unique identifier into the scrambled message for a frame intended for a selected mobile communication device; and
transmitting the frame.

16. The method according to claim 15, wherein transmitting further comprises transmitting the frame on a forward dedicated control channel.

17. The method according to claim 15, wherein incorporating the unique identifier comprises puncturing the unique identifier into the scrambled message.

18. The method according to claim 15, wherein incorporating the unique identifier comprises puncturing the unique identifier into a set of segments of the scrambled message.

19. The method according to claim 15, wherein the unique identifier comprises a mobile station identity code.

20. The method according to claim 15, wherein the unique identifier comprises a mobile station identity code derived from a mobile station identity number.

21. The method according to claim 15, wherein the unique identifier comprises a mobile station identity code derived from a mobile station identity number by performing block coding on the mobile station identity number.

22. The method according to claim 15, wherein the unique identifier comprises a mobile station identity code derived from a mobile station identity number by performing length 16 Walsh block coding on the mobile station identity number.

23. A method on a network of distinguishing a frame on a channel shared by a plurality of mobile communication devices, the method comprising:
identifying a set of mobile communication devices;
determining a unique identifier for at least one of the set of mobile communication devices;
obtaining information bits intended for the at least one of the mobile communication devices;
appending cyclic redundancy code bits to the information bits to obtain a cyclic redundancy coded message;
performing channel coding on the cyclic redundancy coded message to obtain a channel coded message;
scrambling the channel coded message using a long code generated using a mobile communication device specific long code mask to obtain a scrambled message;
incorporating the unique identifier into the scrambled message for a frame intended for a selected mobile communication device; and
transmitting the frame.

24. The method according to claim 23, wherein transmitting further comprises transmitting the frame on a forward dedicated control channel intended for a selected mobile communication device.

25. The method according to claim 23, wherein incorporating the unique identifier comprises puncturing the unique identifier into a set of segments of the scrambled message.

26. The method according to claim 23, wherein the unique identifier comprises a mobile station identity code derived from a mobile station identity number.

27. The method according to claim 23, wherein the unique identifier comprises a mobile station identity code derived from a mobile station identity number by performing block coding on the mobile station identity number.

28. A communication device comprising:
a receiver configured to receive a radio frequency signal for a frame;
a demodulator coupled to the receiver, the demodulator configured to demodulate the signal to obtain a scrambled signal;
a descrambler coupled to the demodulator, the descrambler configured to descramble the scrambled signal to obtain a descrambled signal; and
a unique identifier match module configured to extract a unique identifier from the received signal and also configured to examine the unique identifier extracted from the received signal to determine if the signal is intended for the communication device.

29. The communication device according to claim 28, further comprising a cyclic redundancy code check module coupled to the descrambler, the cyclic redundancy code check module configured to cyclic redundancy code check the descrambled signal.

30. The communication device according to claim 28, wherein receiver is further configured to receive a radio frequency signal for a frame on a forward dedicated control channel during a broadcast multicast service communication.

31. The communication device according to claim 28, further comprising a power controller,
wherein the descrambler is configured to attempt to descramble the scrambled signal using a long code mask and determine the scrambled signal is unsuccessfully descrambled,
wherein the power controller is configured to increase a received signal quality set point if it is determined that the signal is intended for the mobile communication device but the scrambled signal is unsuccessfully descrambled; and
decrease the received signal quality set point if in the examining step it is determined that the signal is intended for the communication device but the scrambled signal is successfully descrambled.

32. A network controller comprising:
unique identifier determination module configured to determine a unique identifier for a communication device recipient of a signal;
a scrambler configured to scramble the signal using a long code generated using a communication device specific long code mask to obtain a scrambled signal;
a unique identifier incorporator configured to incorporate the unique identifier into the scrambled signal for a frame intended for the communication device; and
a transmitter configured to transmit the frame.

33. The network controller according to claim 32, wherein the transmitter transmits the frame on a forward dedicated control channel during a broadcast multicast service session.

34. The network controller according to claim 32, wherein the unique identifier incorporator incorporates the unique identifier into the scrambled signal by puncturing the unique identifier into a power control section of the scrambled signal.

35. The network controller according to claim 32, wherein the unique identifier comprises a mobile station identity code derived from a mobile station identity number of the communication device.
